(19) United States
(12) Patent Application Publication
(10) Pub. No.: US 2016/0243721 A1
(43) Pub. Date: Aug. 25, 2016

(54) Method for Strengthening 3D Printed Components

(71) Applicant: Donald Tew, Burnsville, MN (US)

(72) Inventor: Donald Tew, Burnsville, MN (US)

(73) Assignee: Barristo Enterprises Inc., Chicago, IL (US)

(21) Appl. No.: 15/051,378

(22) Filed: Feb. 23, 2016

Related U.S. Application Data
(60) Provisional application No. 62/119,566, filed on Feb. 23, 2015.
(60) Provisional application No. 62/133,084, filed on Mar. 13, 2015.

(51) Int. Cl. B28B 1/00; C04B 28/14

(52) U.S. Cl. CPC B28B 1/001; C04B 28/14; B33Y 10/00

(57) ABSTRACT

A method of strengthening printed components created by a three-dimensional printing technique utilizes cynoacrylate adhesives. The component is first printed in successive layers of calcium sulfate or similar materials on a three-dimensional printer. The component is next submerged in liquid adhesive contained in a vacuum chamber. A vacuum is applied for a time period to degas the voids and interstices in the material of the component. The vacuum chamber may then be pressurized to transfer liquid adhesive into the evacuated voids. The component is removed from the vacuum chamber and the adhesive allowed to polymerize.

### CROSS-REFERENCE TO RLATED APPLICATIONS

This application claims the benefit of U.S. Provisional Application 62/119566 filed Feb. 23, 2015 and U.S. Provisional Application 62/133084 filed Mar. 13, 2015.

### BACKGROUND

Additive manufacturing refers to recent innovations in which three-dimensional articles or components are constructed by the repeated deposition of materials in successive layers. The layers of material form cross-sectional slices laid adjacent to each other that, when the layering process is complete, are bonded together to produce a three-dimensional finished part. Additive manufacturing enables the ability to produce parts and components with complex and intricate geometries without the need for expensive permanent tooling that would otherwise be required to cast or machine such parts. Examples of additive manufacturing technologies include stereolithography in which a laser beam is directed into a vat of liquid resin material causing the material to cure and harden into the desired shape and, more recently, three dimensional (“3D”) printing techniques. In the later, a specialized printer head configured to form the successive layers is moved repeatedly over a planar surface with the layers created under the head. In extrusion printing, the source material, usually in a liquid or flowable form, is deposited in successive layers on the surface to build up the component. In another 3D printing technique, powder bed printing, the source material in a powder or particulate form is contained in a bed and the moving printer head selectively deposits an activating agent that binds and solidifies the powder into the contiguous layers. Unconverted powder can be reused.

Materials used in 3D printing are characterized by their ability to either be ejected from the printer heads in fine jets or streams for extrusion printing or to rapidly bind into a solid upon contact with the deposited activating agent for powder bed printing. In both instances, the successive layers of printed material coalesce together to form a rigid, three-dimensional part. However, some materials used in 3D printing remain brittle even after the layers have bonded together. For example, 3D printed components made from calcium sulfate or gypsum may be characterized by significant brittleness and lack of strength such that they fracture and/or break under relatively low stresses and loads. This characteristic has inhibited the adoption of such materials in industrial applications for 3D printed components and largely relegated utilization of such materials to prototyping and/or decorative ornamentation. The present disclosure is directed to increasing the utility of these 3D printed articles.

### BRIEF SUMMARY OF THE DISCLOSURE

The present disclosure is directed to strengthening components produced by 3D printing processes from materials that typically demonstrate relative brittleness and a lack of strength. For example, calcium sulfate, which may also be referred to as gypsum or plaster, is a relatively available, inexpensive material that is a suitable for 3D printing techniques because of its capability of being readily converted from a loose powder to an aqueous form by, for example, contact with an activating fluid ejected from the printer head and the ability to readily hind and harden together to form the three-dimensional object from the successive layers. However, hardened calcium sulfate demonstrates significant brittleness and can readily fracture or break even at low stresses or loads.

To increase the strength of the printed component, a relatively strong adhesive in liquid form is applied to the component in a manner that enables the adhesive to permeate into the material prior to setting of the adhesive. Examples of suitable adhesives include cyanoacrylates that may polymerize to form a strongly bonded structure. The typically porous characteristic of the brittle material after it has been printed by the 3D printing process facilitates incorporation of the adhesive into the printed component, in particular, the porosity of the deposited material enables the component to absorb or draw the adhesive into the voids formed. within the material. Adhesive may also be drawn into the voids located at the interface between the adjacent layers of the printed component to bind the layers together. The adhesive sets or hardens within the voids to form a rigid, relatively stronger solid or coating within the voids to increase the strength of the component.

To facilitate filling of voids in the printed component, a vacuum chamber and an associated vacuum system can be employed. After printing, the three-dimensional component can be deposited into the vacuum chamber. The adhesive in liquid form can also be deposited into the vacuum chamber in a quantity or amount such that the component is surrounded by or submerged in the adhesive. The chamber is sealed to atmosphere and a vacuum is drawn on the chamber by a vacuum source to reduce the pressure therein. The vacuum is maintained in the chamber so that any air or gasses trapped in the voids of the material are evacuated. The chamber is then pressurized, for example, by releasing the vacuum and raising the pressure therein to atmospheric pressure which forces and/or draws the liquid adhesive into the evacuated voids. The component with the absorbed adhesive is removed from the chamber and the adhesive is allowed to set and harden within the voids.

A possible advantage of the invention is that the presence of the hardened adhesive in the voids strengthens the printed component relative to its normally brittle characteristic. Another possible advantage is that the alternative application of vacuum and pressure to the 3D printed component forces adhesive deep enough into the voids such that the strength of the component can be increased substantially uniformly through the body of the component. A related advantage is that the 3D printed component can be utilized in applications requiring increased impact strength or fracture toughness. These and other features and advantages of the disclosure will become apparent in view of the drawings and the accompanying detailed description.

### BRIEF DESCRIPTION OF THE DRAWINGS

FIG. 1 is a perspective view of a three-dimensional, printed component made of successive printed layers with a detailed view illustrating the porosity of the component material.

FIG. 2 is a schematic representation of a vacuum chamber system for increasing the strength of 3D printed components produced from gypsum sulfate or similar brittle materials.

FIG. 3 is a flow chart representing a process according to the disclosure for increasing the strength of 3D printed parts produced from gypsum sulfate or similar brittle materials.

FIG. 4 is a graph, with load measured along the Y-axis and strain measured along the X-axis, comparing tensile strength of a printed component strengthened in accordance with the disclosure with a printed component that has not been strengthened.

FIG. 5 is a graph, with load measured along the Y-axis and extension measured along the X-axis, comparing the flexural strength of the printed component strengthened in accordance with the disclosure with a printed component that has not been strengthened.

### DETAILED DESCRIPTION

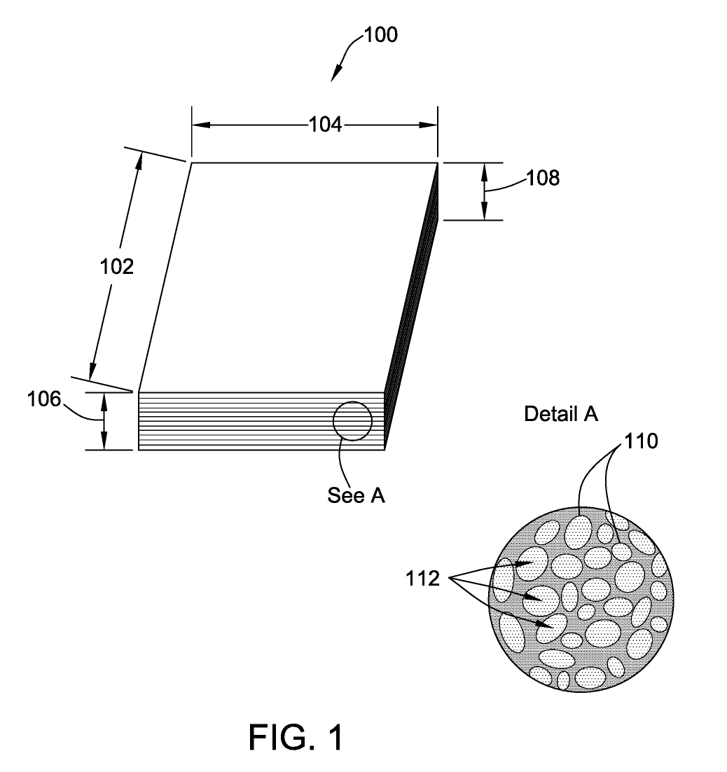

Referring to the drawings, wherein like reference numbers refer to like elements, there is illustrated in FIG. 1 a printed component 100 fabricated from a 3D printing process and having a three-dimensional shape that has been strengthened in accordance with the present disclosure. The illustrated printed component 100 is a square having a generally equal length 102 and width 104, and can have a thickness 106 being less than the dimensions of the length or width, however, in other embodiments, the printed component can have any suitable shape or size that can be produced in accordance with 3D printing techniques. Because the printed component 100 was fabricated using 3D printing techniques, the component can be made of successive layers 108 that have been deposited adjacent one another to create the three-dimensional shape. As described above, the layers 108 may be deposited from the printer head of a 3D printer or similar technology in relatively thin layers, for example, on the order of 1 mm or less. Any suitable 3D printer can be used to print the component including, for example, a ProJet® 860 printer from 3D Systems, Inc.

The layers of the printed component 100 may be made from a material or combination of materials that are suitable for deposit in a bed as particulate matter that can be caused to bind together by the application of an activating agent discharged from a printer head, from heat, ultraviolet light, etc. In another embodiment, the print materials may be discharged directly from a printer head in an initial liquid or aqueous form to facilitate depositing the material in a plurality of successive layers and may thereafter dry to solidify and bind the material together. Referring to detail A, the print material of the printed component 100, after being layered together and solidifying, may be characterized by its porosity. More specifically, the solidified print material may include porous voids 110, or empty spaces, formed within the material. These voids 110 may take the form of pores or bubbles that formed in the print material as it transitions from the liquid or particulate state to the solid printed component. The volume of voids in the printed component compared to the total volume of the component is sometimes referred to as the void fraction or void density. The voids 110 may take different sizes and shapes, may be uniformly distributed or may be concentrated in regions of the component, and may have varying degrees of interconnectedness so that the component is generally open-celled in nature. Different grades of printed material may be selected to adjust void density and pore sizes of the printed component.

An example of a suitable print material in accordance with the disclosure is calcium sulfate, CaSO₄, which may also be referred to as gypsum or plaster, and derivatives thereof. Calcium sulfate is a readily available material suitable for 3D printing applications because it can be converted into an aqueous form by an activating material dispensed from a printer head and thereafter solidified by calcination. Solidification of the material provides the printed component with rigidity and further binds the individual layers together to form an integral component. Examples of calcium sulfate derivatives and related materials include, without limitation, calcium sulfate anhydrous; calcium sulfate hemihydrate; calcium sulfate 1:1 dihydrate; calcium sulfate 1:1 hemihydrate; dental gypsum; dehydrate calcium sulfate; drierite; gypsite; anhydrite; plaster of Paris; lime plaster; lime anhydrous sulfate; and sulfuric acid calcium salt.

One drawback of using calcium sulfate and/or similar materials in 3D printing is that the resulting solid may demonstrate a relatively high degree of brittleness or low fracture toughness such that it may break or fracture under impact or when subjected to stresses or deformation energy. An additional aspect of the 3D printing process is that the interfaces between adjacent layers create a failure point where the printed component may delaminate. In particular, because of the distinct nature of the layers and because the material of the layers hardens at different rates, the adjacent layers may not be strongly bonded to each other compared to bonding of the material within the layers. The interfaces between layers may be characterized by a high degree of porosity and divided or unconnected material that facilitates separation of the printed component. The layers may also have different physical characteristics, with earlier created layers different than later created layers.

To strengthen the printed component, in accordance with the disclosure, an adhesive in liquid form can be applied to the part and allowed to set and harden. The adhesive can be selected so that, when set, the adhesive demonstrates greater strength and impact resistance than the solidified print material, thereby imparting increased strength to the overall printed component. Advantage can be taken of the porosity of the solidified material of the printed component by retaining or accommodating at least some of the adhesive in the voids. For example, referring to Detail A of FIG. 1, the adhesive 112 can fill in or at least coat the inner surfaces of the voids 110 that are dispersed throughout the printed component 100 such that, when the adhesive sets, it forms a rigid or hardened internal structure in the component. In addition, the adhesive can fill the voids present at the interfaces between the layers to strengthen the bond between layers and prevent de-lamination of the component. The interfaces particularly serve to accommodate adhesive that, when set, strengthens the part. Further, because the adhesive permeates through the material of the part, the adhesive provides more uniform physical and/or structural characteristics between the different layers.

Cyanoacrylates are examples of suitable adhesives for use with the disclosed process, Cyanoacrylates are strong, fast acting adhesives that quickly form strong, irreversible bonds. Cyanoacrylates are initially in a liquid state containing monomers that rapidly polymerize into long chained molecules in the presence of water. The molecular chains intertwine and link to form strong bonds resulting in a rigid structure. In liquid form, cyanoacrylates are transparent and typically have viscosities, on the order of 1 to 2500 centipoise that enables the adhesive to permeate and flow through the interconnected voids. Cyanoacrylates are available in variations including methyl 2-cyanoacrylate, ethyl-2-cyanoacrylate, butyl cyanoacrylate, and octyl cyanoacrylate.

In a preferred embodiment, the cyanoacrylate will be methoxyethyl cyanoacrylate that may or may not be used in combination with additives to assist the strengthening process. One example of a preferred formulation of the cynaoacrylate is 2-methoxyethyl 2-cyanoacrylate in combination with hydroquinone and crown ether. The percent compositions of the preferred formulation can be at least 98% 2-methoxyethyl 2-cyanoacrylate with 1% hydroquinone and 1% crown ether; more preferably at least 99% 2-methoxyethyl 2-cyanoacrylate, with 0.5% hydroquinone and 0.5% crown ether, and even more preferably 99.8% 2-methoxyethyl 2-cyanoacrylate with 0.1% hydroquinone and 0.1% crown ether. This preferred formulation is characterized by viscosities of 25 centipoise or less, and more preferably viscosities of 10 centipoise or less, and has a viscosity of approximately 5 centipoise and flow characteristics approaching that of or similar to water. The preferred formulations are typically transparent both in liquid form and when hardened, but in other embodiments different colors or hues can be selected.

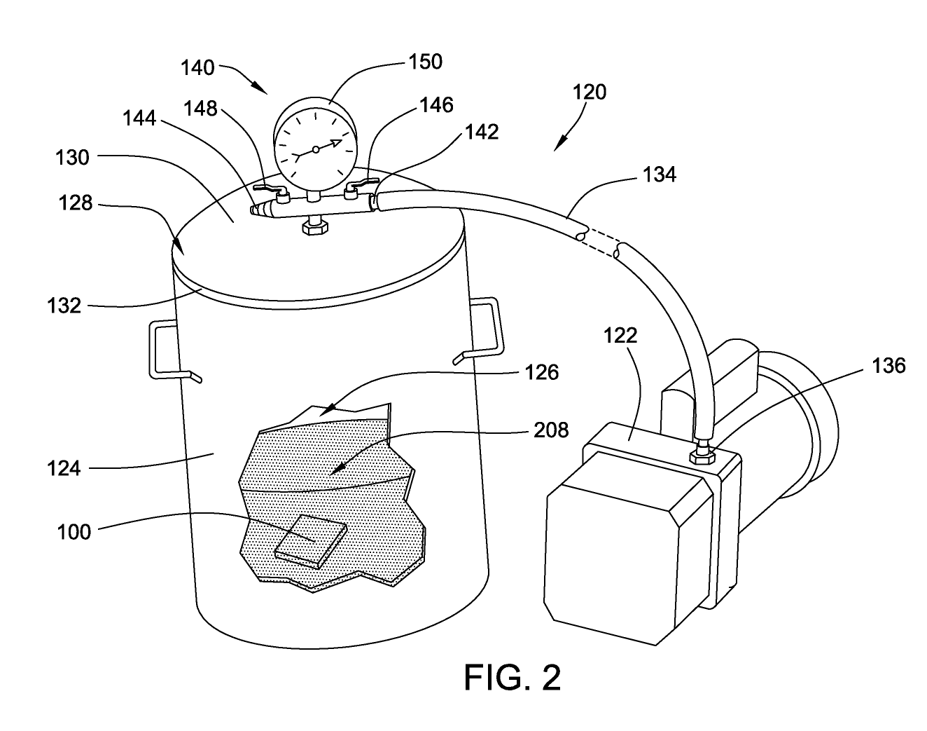

To transfer the adhesive into the voids, the application of adhesive to the printed components can be performed under a vacuum created in a vacuum system. Referring to FIG. 2, there is illustrated an example of a suitable vacuum system 120 for carrying out the strengthening process. The vacuum system 120 may include a vacuum pump 122 and a vacuum chamber 124. The vacuum pump can be any suitable vacuum pump such as an oil-sealed rotary vane type pump as illustrated but, in other embodiments, other vacuum sources can be used. The vacuum pump 122 or other vacuum source may be capable of drawing sufficient vacuum for purposes of the disclosed strengthening process, and preferable drawing vacuum down to 25 or less Hg (Torr) (3.3 kPa), and more preferably 10 or less Hg (Torr) (1.3 kPa). In the illustrated embodiment, the vacuum chamber 124 can be cylindrical and is hollow to define an interior space 126 for evacuation. The size and volume of the chamber can be dependent upon the size of the parts being strengthened. The body of the vacuum chamber 124 can be made from a suitable, vacuum tight material such as stainless steel. To access the interior space 126, the top of the vacuum chamber 124 can provide an opening 128. To enclose the interior space 126, when for example, applying a vacuum to the vacuum chamber 124, a removable cover 130 can be placed over the opened top 128 and can form an airtight seal 132 with the rim of the open top. To observe the interior space 126, the cover 130 can be transparent.

To establish fluid communication between the vacuum chamber 124 and the vacuum pump 122, a vacuum hose 134 or tubing can be coupled to an inlet 126 on the vacuum pump and connected to a fitting 140 disposed on the cover 130 and which communicates with the interior space 126 of the chamber. The fitting 140 can be a Tee or cross and can include a first barb 142 coupled to the vacuum hose 134 and an oppositely directed second barb 144 that, in the illustrated embodiment, may communicate with atmosphere. The first barb 142 and the second barb 144 can be operatively associated with a first handle-operated valve 146 and a second handle-operated valve 148, respectively, which can selectively open the barbs to or seal the barbs from communication with the interior space 126 of the vacuum chamber 124. The valves 146, 148 are preferably sufficient to maintain a vacuum inside the vacuum chamber 124 when the valves are closed. To monitor pressure inside the vacuum chamber 124, the fitting 140 can include a pressure gauge 150 or meter, which may be physically actuated or digital, that is in continuous communication with the interior space 126.

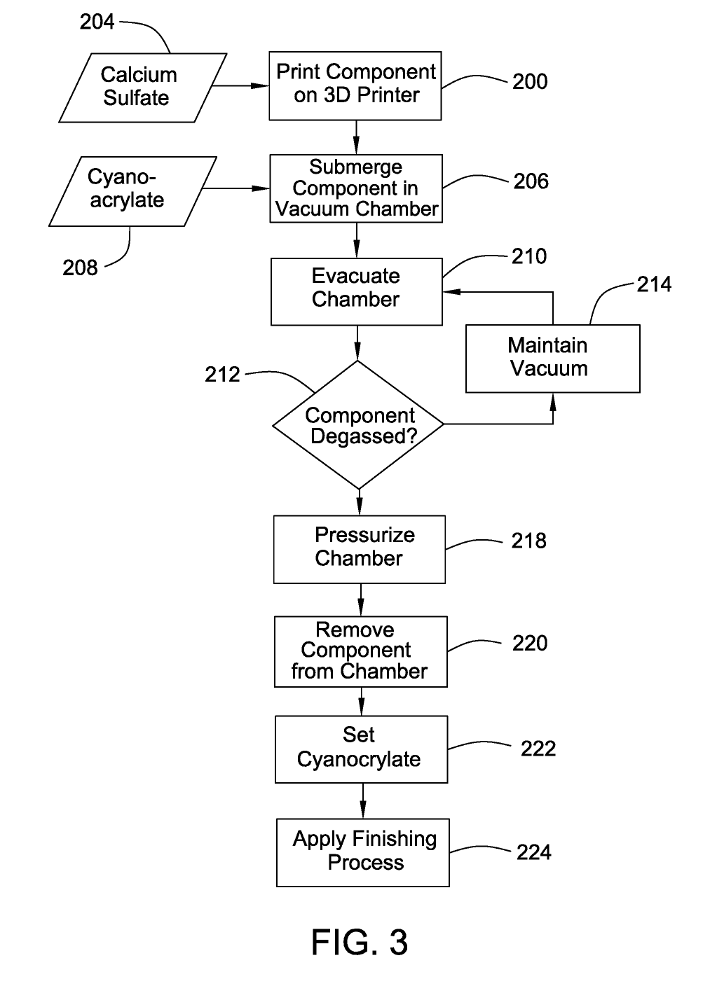

Referring to FIG. 3, there is illustrated a flowchart 200 for carrying out the strengthening process in accordance with the disclosure. In an initial printing step 202, the printed component is fabricated according to 3D printing techniques such as a 3D printer. This can be done on any suitable 3D printer including those using powder bed and inkjet technology, extrusion technology, or the like. The print material for the printed component can be powder-based and that will have a degree of porosity when solidified. Preferably the material is calcium sulfate 204 or a calcium sulfate derivative that is supplied to the 3D printer. Once the successive layers of the print material are deposited and bind together, a submersion step 206 is performed where the printed component is placed in a vacuum chamber along with a liquid adhesive such as liquid cyanoacrylate 208. The cyanoacrylate 208 may be introduced into the vacuum chamber prior to or after the printed part is deposited in the vacuum chamber. A linear may be placed in the chamber to facilitate removal of cyanoacrylate and cleaning of the chamber. To maintain the liquid state of the cyanoacrylate in the chamber, inhibitors can be added. Referring back to FIG. 2, in an embodiment, the quantity of cyanoacrylate 208 introduced to the vacuum chamber 124 preferably should be sufficient to completely submerge and wet the printed component 100 which may be located below the surface of the liquid.

Referring to FIGS. 2 and 3, to evacuate the voids in the printed component and the voids created by the interfaces between the layers, an evacuation step 210 in which a vacuum from the vacuum pump 122 or other vacuum source is applied to the vacuum chamber 124. To facilitate the evacuation step 210, the first barb 142 may communicate with the vacuum pump 122 by opening the first valve 146 and the second barb 144 may be closed to atmosphere by closure of the second valve 148. The vacuum pump 122 removes air from the interior space 126 thereby reducing the pressure in the vacuum chamber 124. In various embodiments, a trap can be placed in the vacuum hose 134 and/or a filter attached to the vacuum pump 122 to eliminate fumes. When the pressure inside the vacuum chamber 124 is sufficiently low, for example, less than 10 Hg (Torr) (1.3 kPa), air or gasses trapped in the voids of the printed component will be drawn out of the part and rise through the liquid cyanoacrylate for removal from the interior space 126.

The evacuation process preferably occurs for a sufficient duration so that the voids are substantially evacuated, which can be determined through a determination step 212. For example, the process of degassing the printed component may form bubbles within the liquid cyanoacrylate indicating the evacuation of the voids is continuing. The transparent nature and low viscosity readily permits the formation of visible bubbles during evacuation to provide a visual indication the part is degassing. The evacuation process can be monitored by observation through the clear cover 130 and the readings on the vacuum gauge 150. If the bubbles are still forming, the vacuum drawn on the vacuum chamber 124 can be maintained through a maintenance step 214 which continues evacuating the interior space 126. If bubbles stop forming, indicating the voids are evacuated, the determination step 212 determines that the printed component is evacuated and the strengthening process proceeds. The characteristics and low viscosity of cyanoacrylates also facilities the visual indication that the evacuation process is complete. In alternative embodiments, the determination step 212 can be made based on times and vacuum pressures required to evacuate parts of known sizes, which information can be obtained empirically.

To transfer the liquid cyanoacrylate into the evacuate voids and the interfaces between adjacent layers, a pressurization step 218 occurs in which the interior space 126 is pressurized. To accomplish pressurization, communication with the vacuum pump 122 can be cut off by closing the first handle 146 and the vacuum chamber 124 can be vented to atmosphere or an inert gas can be introduced by opening the second handle 148. Venting the vacuum chamber to atmosphere raises the pressure in the interior space 126 forcing liquid cyanoacrylate into the evacuated voids of the submerged printed component. The vacuum chamber can be left at atmospheric pressure for a period to ensure that liquid cyanoacrylate is sufficiently absorbed into the voids. If the voids are interconnected, the cyanoacrylate may permeate through the part. The low viscosity of cyanoacrylate assists in substantially complete permeation and rapid filling of the voids when the chamber is pressurized. In case where the printed component may have exceptionally smaller pore sizes, i.e. on the macroscopic level, a low viscosity cyanoacrylate facilitates complete permeation of the printed component and the transfer of cyanoacrylate through the smaller interconnected voids. In embodiments processing relative large components, absorption of the cyanoacrylate can be hastened by positively pressurizing the vacuum chamber 124 relative to atmosphere. In various embodiments, depending upon component size, the printed component may absorb between 25% and 50% by weight of the cyanoacrylate. The absorbed weight percentage of cyanoacrylate may be adjusted by selecting different grades of calcium sulfate material to produce different void densities and pore sizes.

The submersion and penetration steps can be advantageously carried out with the preferred formulation of methoxyethyle cyanoacrylate and similar cyanoacrylates. In particular, the preferred formulations may be characterized by viscosities of 5 centipoise or less that facilitates penetration of the printed component by allowing the cynoacrylate to flow into the voids and into the interfaces between the printed layers. In various embodiments, full penetration of cyanoacrylate through the voids and interfaces of a typically sized printed component, for example, 3 cm×3 cm×3 cm, can be achieved in less than three minutes when the chamber is returned to atmospheric pressure. The preferred formulations also facilitate preparation and execution of the strengthen process because they are single component, application-ready adhesives that do not require mixing and that are available in quantities sufficiently cost effective to fill the chamber in amounts to submerge the printed component.

The printed component with absorbed cyanoacrylate can be removed from the vacuum chamber in a removal step 220 and set or hung to dry so that the cyanoacrylate may set within the voids in a setting step 222. Because cyanoacrylates are quick-setting adhesives, the setting step 222 can typically occur at room temperature and standard humidity by allowing the parts to stand for 10 to 30 minutes depending on part size. Because the polymerization of cyanoacrylates can be triggered by exposure to HA moisture in the atmosphere will interact with the cyanoacrylate on and in the printed components once they are removed from the chamber. Activation and hardening of the cyanoacrylate can be initiated at the exterior surfaces of the components where the cyanoacrylate is present and the polymerization reaction can work into the component changing the adhesive retained in the interconnected voids, in some embodiment, the void sizes in the printed parts can be selected to quicken thorough hardening, with smaller voids retaining less cyanoacrylate hardening faster than larger voids containing larger volumes of cyanoacrylate. In some examples with typically sized components, the components may be ready to touch in 20 or 30 seconds with full polymerization occurring later. However, in various embodiments, accelerators can be applied to quicken the setting time. In addition, the component may be heated, pressurized, and/or, if an appropriate adhesive is used, exposed to light to hasten the setting time.

Typically, the hardened cyanoacrylate can form a smooth, highly transparent surface on the component. In addition, hardened cyanoacrylates are resistant to H₂O and can water or moisture proof a printed component. In an embodiment, to improve the appearance of the printed component, a finishing step 224 can be applied. An example of a finishing process is to apply additional cyanoacrylate and/or an accelerator to the surfaces of the component, for example, by re-submerging the component in the vacuum chamber, and the component is allowed to dry thereby leaving a gloss or finish on the component surfaces. Further, the surfaces of the printed component may be sprayed with cyanoacrylate having the same or different characteristics to provide a surface finish for the part. In other embodiments, the liquid cyanoacrylate can be wiped off the surfaces of the component immediately after removal from the chamber to preserve the surface finish of the component as printed. In embodiments where transparent cyanoacrylate is used, the natural or selected color of the printing material is preserved and is visible through the adhesive, however, in other embodiments, cyanoarcylates of different colors or hues can be used.

The process can be configured to preserve the liquid cyanoarcylate for repeated applications. In particular, the liquid cyanoacrylate will not begin to polymerize in the vacuum chamber in the absence of an activator such as H₂O, especially when maintained under vacuum and when a suitable inert linear is placed in the chamber. In an embodiment, the vacuum chamber can be backfilled with an inert gas such as nitrogen to prevent activation of the liquid cyanoacrylate. In addition, the preferred formulations are characterized by being low blooming, meaning the cyanoacrylate molecules will not readily vaporize, due to their molecular structure and molecular weight. The low blooming characteristic preserves the liquid cyanoacrylate in the chamber and prevents the cyanoacrylate on the curing printed component from evaporating and resettling on the surfaces of the part in a manner that may disrupt the surface finish and discolor the component.

The following examples further illustrate the invention but, of course, should not be construed as in any way limiting its scope.

### EXAMPLE 1

This example demonstrates strengthening of a printed component in accordance with the disclosure. In this example, two samples were prepared including a strengthened sample and a baseline sample, Both samples were dimensioned 1 inch in length by 1 inch in width by 1/16 inch in height (1″×1″× 1/16″) and were printed on a ProJet®860 printer using VisiJet® PLX material, both available from 3D Systems Inc. VisiJet® PLX is a calcium sulfate (gypsum) based printing material. After printing and solidification of the print material, the baseline sample was considered complete and no further preparation was done.

To prepare the strengthened sample, the strengthened sample was completely submerged in a vacuum chamber with a liquid cyanoacrylate adhesive having viscosities of 1 to 2500 centipoise. The cyanoacrylate used was SureHold® type 201, a methoxyethyl cyanoacrylate, characterized by low bloom, slow cure, and low out gassing, available from SureHold®. A vacuum of 10 Hg (Torr) was applied to the chamber for approximately 10 minutes, at the conclusion of which bubbles in the cyanoacrylate stopped forming. The vacuum to the chamber was cutoff and the chamber was pressurized by venting to atmosphere for approximately 3 minutes, with the strengthened sample remaining submerged in the liquid cyanoacrylate. After pressurization, the strengthened sample was removed from the vacuum chamber and dried at room temperature for approximately 10 minutes to set the cyanoacrylate.

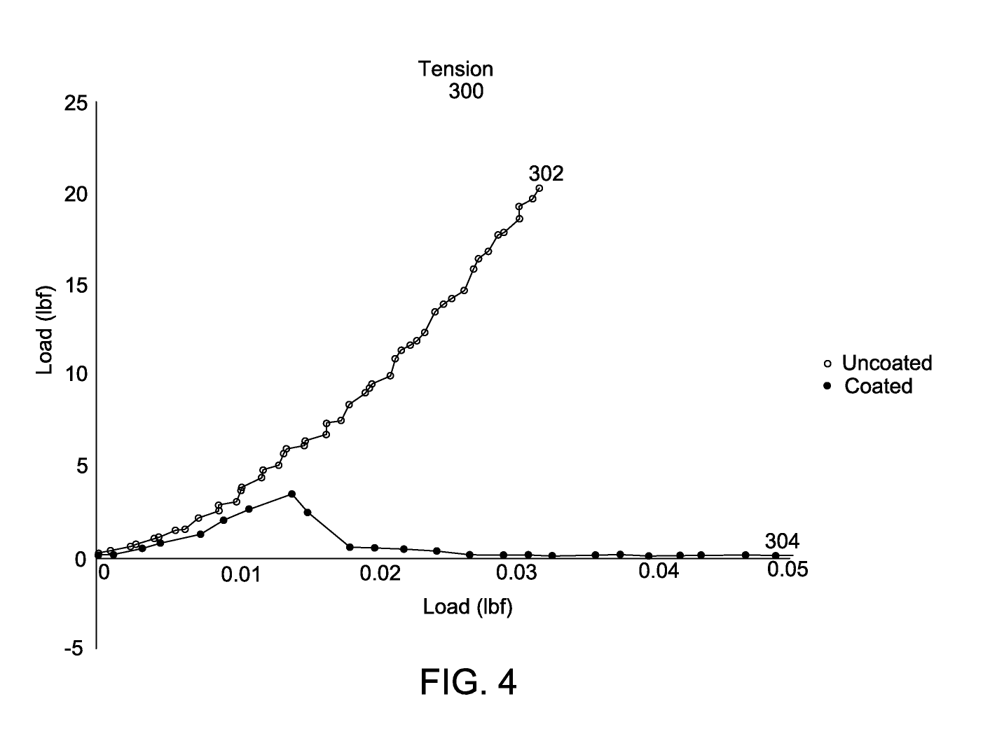

The strengthened sample and the baseline sample were subjected to strength tests and the results compared. FIG. 4 is a graph 300 comparing the performance of the samples under tensions, with load represented along the Y-axis in foot-pounds (lbf) and strain represented along the X-axis as a percentage of elongation. The samples were placed under tension by gripping opposing edges of the sample. The results for the strengthened sample are plotted in orange along curve 302 and the results for the baseline sample are plotted in blue along curve 304. The strengthened sample was able to withstand a load of approximately 20 lbf and incurred a strain of approximately 0.03. The baseline sample, in contrast, was able to withstand a load of about 3 lbf, at which point the baseline sample failed. This result represents the strengthened sample as having an increase in tensile strength over 6 times that of the baseline sample

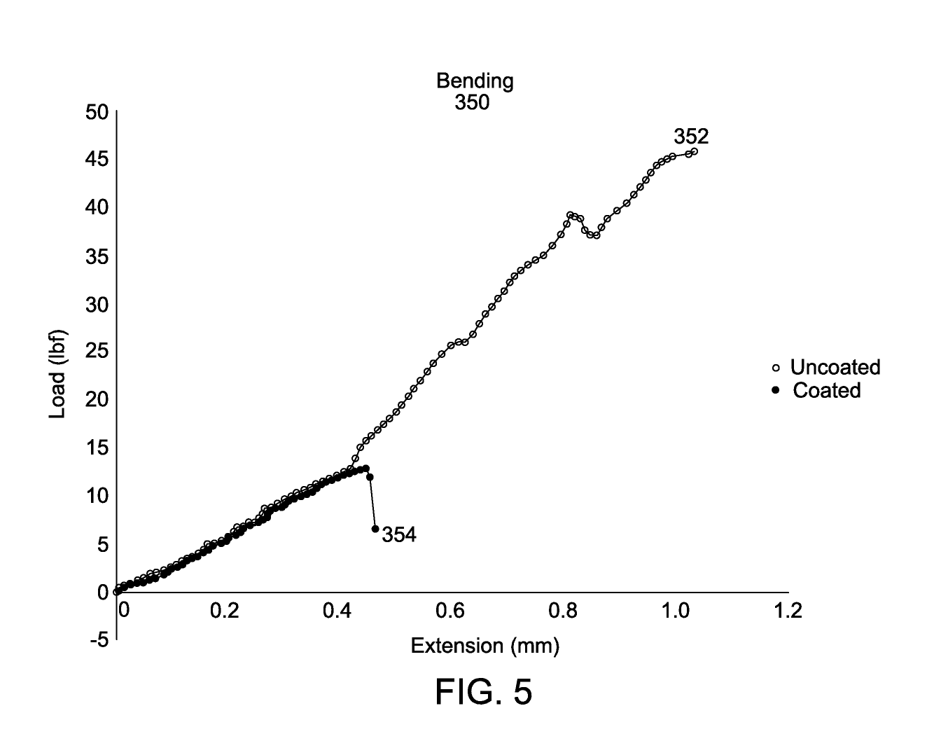

FIG. 5 is a graph 350 comparing the performance of the samples under bending or flexural conditions, with load represented along the Y-axis in foot-pounds (lbf) and extension or distortion represented along the X-axis in millimeters (mm). The samples were placed in flexure by bending the sample with respect to their height. The results for the strengthened sample are plotted in orange along curve 352 and the results for the baseline sample are plotted in blue along curve 354. The strengthened sample was able to withstand approximately 45 lbf with accompanying extension of approximately 1 mm. The baseline sample, in contrast, was able to withstand approximately 12.5 lbf with an accompanying extension of approximately 4 mm extension before failure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example; “at least one of A and B”) is to be construed to mean one item selected from the listed items (A or B) or any combination of two or more of the listed items (A and B), unless otherwise indicated herein or clearly contradicted by context. The terms “comprising” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of increasing the strength of a printed component comprising:
forming a printed component from successive layers deposited by a three-dimensional printing technique;
submerging the printed component in a liquid adhesive within a vacuum chamber;
applying a vacuum to the vacuum chamber to evacuate gasses from voids in the printed component;
pressurizing the vacuum chamber to transfer liquid adhesive into voids; and
removing the printed component from the vacuum chamber and allowing the liquid adhesive to polymerize in the voids.

2. The method of claim 1, wherein the adhesive is a cyanoacrylate.

3. The method of claim 2, wherein the cyanoacrylate is selected from the group consisting of methyl 2-cyanoacrylate, ethyl-2-cyanoacrylate, butyl cyanoacrylate, and 2-octyl cyanoacrylate.

4. The method of claim 2, wherein the cyanoacrylate has a viscosity of 2500 centipoise or less.

5. The method of claim 2, further comprising applying an accelerator to the printed component to accelerate setting of the cyanoacrylate.

6. The method of claim 2, further comprising applying an inhibitor to the cyanoacrylate prior to submerging the printed component.

7. The method of claim 2, further comprising finishing the printed component by applying additional cyanoacrylate to the surface of the printed component after removal from the vacuum chamber.

8. The method of claim 1, wherein the printed component is printed of a print material including calcium sulfate or a derivative thereof.

9. The method of claim 1, wherein the printed component is printed of a print material selected from the group consisting of calcium sulfate; calcium sulfate anhydrous; calcium sulfate hemihydrate; calcium sulfate 1:1 dihydrate; calcium sulfate 1:1 hemihydrate; dental gypsum; dehydrate calcium sulfate; drierite; gypsite; anhydrite; plaster of Paris; lime plaster; lime anhydrous sulfate; and sulfuric acid calcium salt.

10. The method of claim 1, wherein the printed component absorbs between 25% and 50% by weight of the liquid adhesive.

11. The method of claim 1, wherein the strengthened printed component demonstrates at least a 6-fold increase in tensile strength

12. The method of claim 1, wherein the strengthened printed part demonstrates at least a 3-fold increase in flexural strength.

13. A printed component strengthened in accordance with claim 1.
